(19) United States
(12) Patent Application Publication
(10) Pub. No.: US 2011/0054858 A1
(43) Pub. Date: Mar. 3, 2011

(54) METHOD FOR MEASURING HUMIDITY DISSIPATION PROPERTIES OF AN ABSORBENT ARTICLE

(76) Inventors: Sergio Luiz de Oliveira, Sao Paulo dos Campos (BR); Marcelo Francisco de Azevedo Silva, Sao Jose dos Campos (BR)

(21) Appl. No.: 12/710,452

(22) Filed: Feb. 23, 2010

Related U.S. Application Data
(60) Provisional application No. 61/231,375, filed on Aug. 5, 2009.

(51) Int. Cl. G06F 17/10

(52) U.S. Cl. 703/2

(57) ABSTRACT

A method of calculating the humidity dissipation of an absorbent article including the steps of collecting relative humidity data from an absorbent article for a selected period of time, generating a graph plotting relatively humidity versus time for the absorbent article, differentiating the relative humidity versus time graph to obtain a differential graph.

### FIELD OF THE INVENTION

The present invention generally relates to method for measuring the relative humidity of a disposable absorbent article, and more particularly to a method of measuring the humidity dissipation properties of a disposable absorbent article.

### BACKGROUND OF THE INVENTION

Externally worn, sanitary absorbent napkins are one of many kinds of feminine protection devices currently available. Sanitary napkins conventionally have a laminate construction including a body-facing liquid permeable layer, an absorbent core layer or layers, and a liquid impermeable garment facing layer. A problem with conventional napkins, due to the laminate construction thereof, is that such articles are not particularly breathable within the absorbent layers of the article. This lack of “internal breathability” within the article construct can cause comfort problems for the user during use of the article. In particular, the lack of internal breathability in conventional articles may cause the users body temperature to rise in a localized area thereby creating discomfort during use. Further, once the article becomes wet, the lack of internal breathability may prevent the article from drying thereby imparting a wet sensation to the user during use.

The inventors of the present invention have discovered a method of measuring the humidity dissipation properties of a disposable absorbent article such as a sanitary napkin. The method allows the inventors to evaluate the humidity dissipation performance of a disposable absorbent article and thereby predict the comfort attributes of the article.

### SUMMARY OF THE INVENTION

In view of the foregoing, the present invention provides a method of calculating the humidity dissipation of an absorbent article including the steps of collecting relative humidity data from an absorbent article for a selected period of time, generating a graph plotting relatively humidity versus time for the absorbent article, differentiating the relative humidity versus time graph to obtain a differential graph, obtaining a first tangent line from the differential graph, obtaining a second tangent line from the relative humidity versus time graph, transcribing the first and second tangent lines onto the relative humidity versus time graph, and calculating a humidity dissipation A_{RH} value by determining the area located between the first and second tangent lines and the relative humidity versus time graph.

### BRIEF DESCRIPTION OF THE DRAWINGS

Examples of embodiments of the present invention will now be described with reference to the drawings, in which:

FIG. 1 is a schematic view of an apparatus for measuring relative humidity of an absorbent article;

FIG. 2 is a perspective view of an absorbent article with the temperature and relatively humidity microsensors of the apparatus depicted in FIG. 1 inserted under the cover layer and into the core layer thereof;

FIG. 2a is a detailed sectional view of the absorbent article shown in FIG. 2 depicting the insertion of the temperature and relatively humidity microsensors into the core layer of the absorbent article;

FIG. 3 is a partially exploded view depicting additional features of the apparatus shown in FIG. 1;

FIG. 4 is a perspective view showing the absorbent article positioned for testing in the apparatus shown in FIG. 3;

FIG. 5 is a graph plotting relatively humidity versus time for an absorbent article tested according to the test method set forth herein;

FIG. 6 is a graph depicting the differential plot of the graph shown in FIG. 5;

FIG. 7 is a graph showing the manner in which X₁ and Y₁ are determined according to the test method set forth herein;

FIG. 8 is a graph showing how a first tangent line is determined for the graph shown in FIG. 5 based on X₁ and Y₁;

FIGS. 9 and 10 are graphs depicting the manner in which a second tangent line is determined for the graph shown in FIG. 5; and

FIG. 11 is graph depicting the manner in which A_{RH} is calculated based upon the first and second tangent lines.

### DETAILED DESCRIPTION OF THE INVENTION

The method described herewith will be described with reference to a sanitary napkin, however the inventive method may be used to evaluate other disposable absorbent article such as panty liners, incontinence products, and the like.

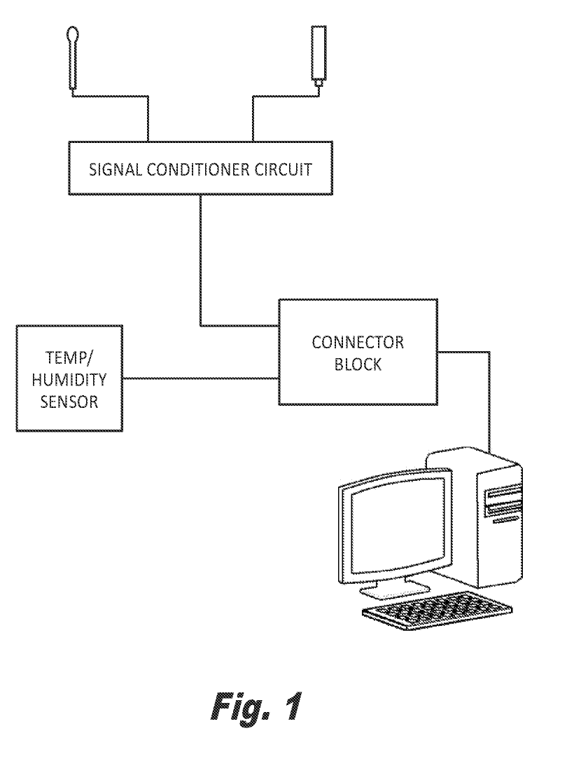

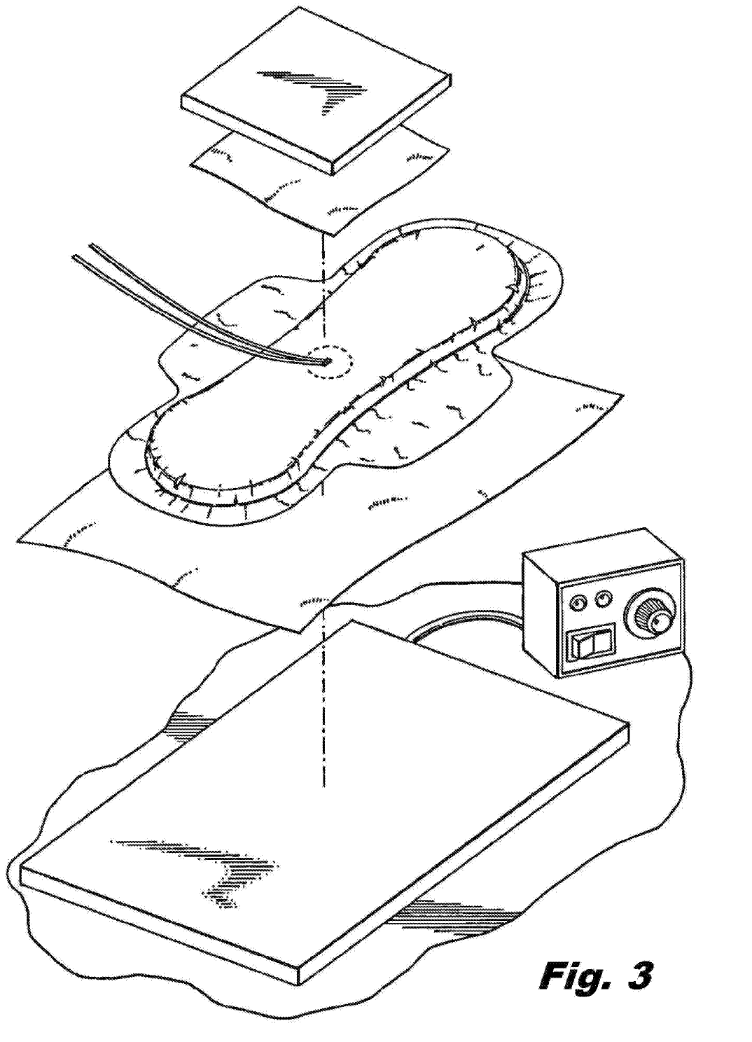

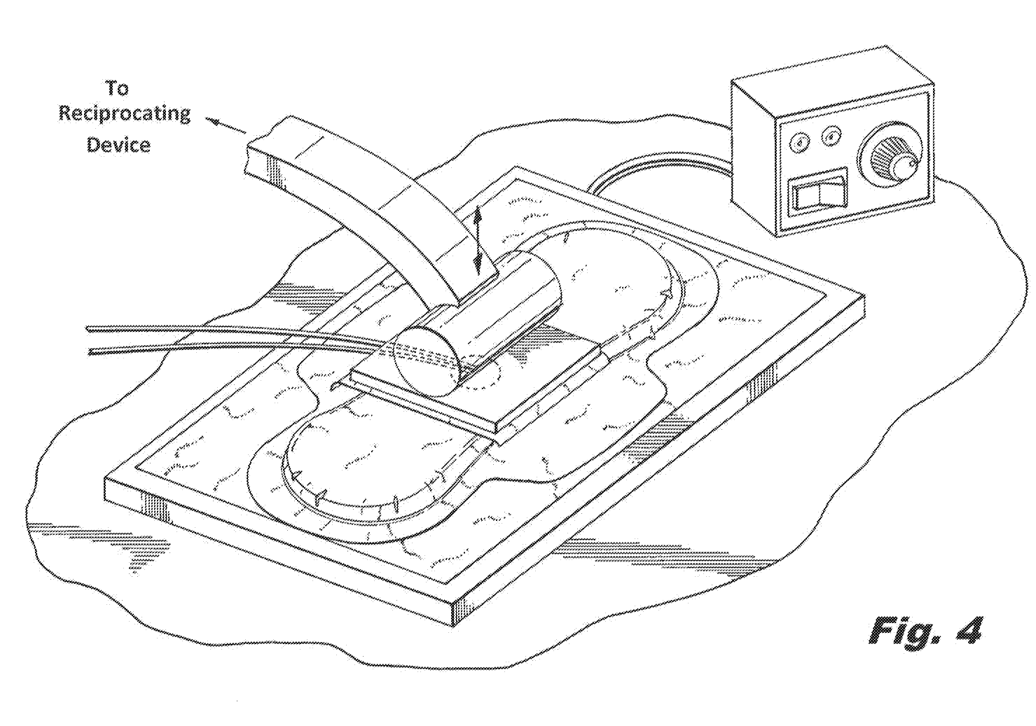

Reference is made to FIG. 1 which schematically depicts an apparatus 10 for measuring the humidity dissipation characteristics of an absorbent article according to the test method set forth in detail below. The apparatus 10 generally includes a relative humidity microsensor 12 for measuring the relative humidity of an absorbent article, a microsensor 14 for measuring the temperature of an absorbent article, a temperature and humidity sensor 16 for measuring the temperature and relative humidity of a laboratory in which the test is being conducted, a signal conditioner 20, a connector block 22 and a computer 24 for recording the measured data. The apparatus 10 further includes a heating plate 26 as shown in FIGS. 3 and 4.

Two acrylic plates 28 each having dimensions of 5.0 cm (length) by 5.0 cm (width) by 0.2 cm (thick) are used in the test method described below. One of the above described acrylic plates 28 is depicted in FIG. 3. A cotton panty 30, as shown in FIG. 3, is also required to perform the test method set forth below.

A suitable commercially available microsensor 12 is the relative humidity microsensor model HIH-400 manufactured by Honeywell International, Inc., Morristown, N.J.

A suitable commercially available microsensor 14 is temperature microsensor model NTC manufactured by BetaTherm, Inc., Hampton, Va.

The same commercially available temperature and relative humidity microsensors described above may be used as the sensor 16 to measure the temperature and relative humidity of the laboratory in which the test is being conducted.

The electronic interface 20 is a conventional signal conditioner circuit.

A suitable commercially available connector block 22 is connector block model NISCC-68 manufactured by National Instruments Corporation, Austin, Tex.

The computer 24 is a Microsoft Windows based system equipped with LabView, version 7.1, manufactured by National Instruments Corporation, Austin, Tex. The identified software is used to collect and process the transmitted data.

A suitable commercially available heating plate 26 is the Multi-Blok Heater, Model 2050, manufactured by Lab-Line Instruments, a subsidiary of Breanstead Thermolyne, Melrose Park, Ill.

The cotton panty 30 used in the test method may be any conventional commercially available panty having a composition of at least 90% cotton.

As shown in FIG. 4, the apparatus 10 further includes a cylindrical mass 34 having an outer diameter of 3.0 cm, a length of 8.5 cm and a mass of 77.3 g. The cylindrical mass 34 may be constructed as an acrylic tube filled with sand or the like to achieve the required mass and sealed on each end thereof. The cylindrical mass 34 is connected to a rigid swing arm 35, which is in turn connected any suitable apparatus capable of moving the mass 34 in a repeating up and down vertical motion to thereby apply a repeating force to the acrylic plate 28 as shown in FIG. 4. The apparatus to which the mass 34 it attached, by means of the swing arm 35, should be selected such that the mass 34 applies a force of 12 g once per second to the acrylic plate 28. A suitable commercially available apparatus capable of moving the swing arm 35 and mass 34 in this manner, and applying the required force, is a thermostatic bath Haake SWB 20 Fisons TYP 000-8582/194015695002 KL DIN 12879 manufactured by Haake Fisons.

As shown in FIG. 3, one of the surfaces of the acrylic plate 28 is covered by a 5 cm (length)×5 (width) cm×0.1 cm (thickness) swatch of nonwoven material 36. The nonwoven material 36 is attached to the acrylic plate 28 by applying 3.6 gsm (g/m²) adhesive (Pritt non-toxic Stick manufactured by Henkel Capital, S.A., Mexico) over a 25 cm² area to the acrylic plate facing surface of the nonwoven material 36. The nonwoven material 36 has a basis weight of 180 gsm and a composition of 100% wool fibers. A suitable commercially available material of this type is available from Indústria de Feltros Santa Fé Av. Antônio Bardella, 780, Cumbica, Guarulhos-SP Brazil.

Prior to conducting the test method set forth below the product specimens to be measured are conditioned by leaving them in a room that is 22° C., +/−2° C. and 55%, +/−3.0% relative humidity for a period of twelve (12) hours. In addition, for each product specimen to be tested, two acrylic plates 28, with the nonwoven swatch of material 36 attached thereto, are conditioned by leaving them in a room that is 22° C., +/−2° C. and 55%, +/−3.0% relative humidity for a period of twelve (12) hours. Three identical product specimens are required for each product to be tested.

The test method described below should be conducted in a laboratory setting having a temperature of 22° C., +/−2° C., and a relative humidity of 55%, +/−3.0%.

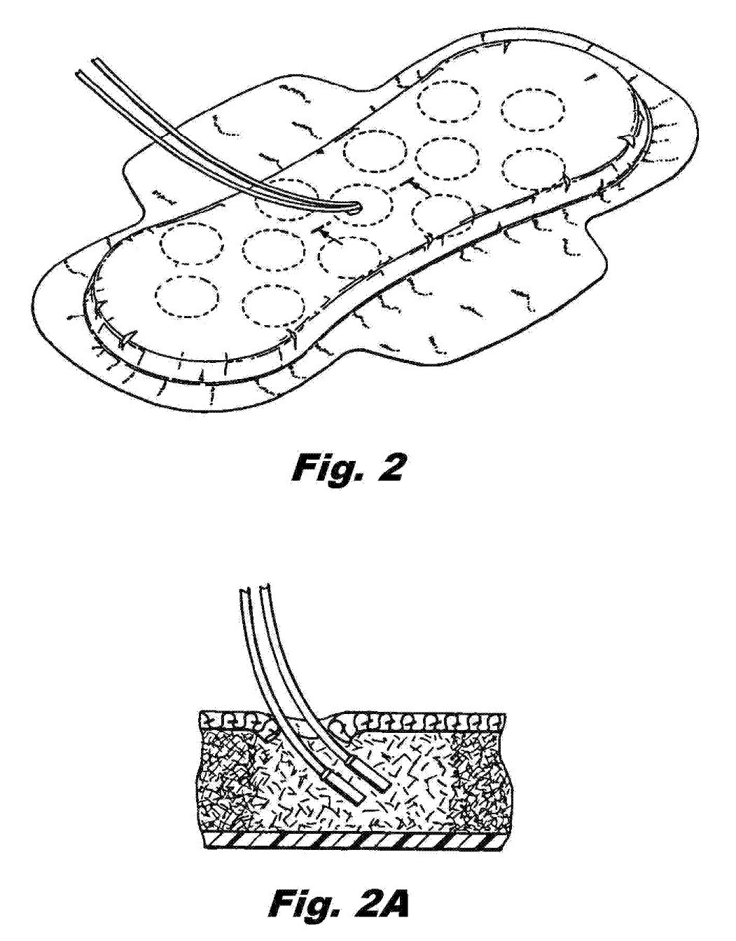

As shown in FIGS. 2 and 2a, the test method is initiated by inserting the microsensor 12 and the microsensor 14 under the cover layer 42 and into the absorbent core layer 44 of the absorbent article 40 at the intersection of the longitudinally extending centerline 50 and transversely extending centerline 52 of the absorbent article 40. A small hole may be formed in the cover layer 42, if necessary, to facilitate the insertion of the microsensors 12 and 14.

After the microsensors 12 and 14 are inserted under the cover layer 42 and into core layer 44 the absorbent article 40 is attached to the panty 30 by means of positioning adhesive located on the garment facing surface of the barrier layer 60 of the absorbent article 40. If the article to be tested does not include positioning adhesive the article may be attached to the panty 30 using conventional masking tape or the like.

After the napkin 40 is attached to the panty 30, the panty 30 is arranged on the heating plate 26, as shown in FIGS. 3 and 4, such that the panty 30 is adjacent the top surface of the heating plate 26 and the napkin 40 faces away from the top surface of the heating plate 26. Thereafter one of the conditioned acrylic plates 28 is arranged on top of the napkin 40 such that the center of the plate 28 is arranged over the intersection of the longitudinally extending centerline 50 and transversely extending centerline 52 of the napkin 40. The plate 28 is arranged such that the nonwoven swatch of material 36 is placed in abutting face to face relationship with the top surface of the cover layer 42. The cylindrical mass 34 is then positioned such that the central axis thereof is aligned with the longitudinally extending centerline 50 of the napkin 40.

After the apparatus 10 is configured as described above, the movement of the cylindrical mass 34 is initiated and the relative humidity and temperature of the napkin 40 is monitored via the readout provided by the computer 24. The objective of this first step of the method is to obtain an equilibrium temperature and relative humidity within the napkin 40. Specifically, the objective is to obtain conditions within the napkin 40 such that the temperature of the napkin is between 36° and 38° C. and the relative humidity of the napkin is between 25% to 30%. Equilibrium is established when the napkin 40 has a temperature between 36° and 38° C. and a relative humidity between 25% to 30% for a period of one minute. The temperature of the napkin 40 may be increased, if necessary, to reach the required equilibrium temperature by means of the heating plate 26.

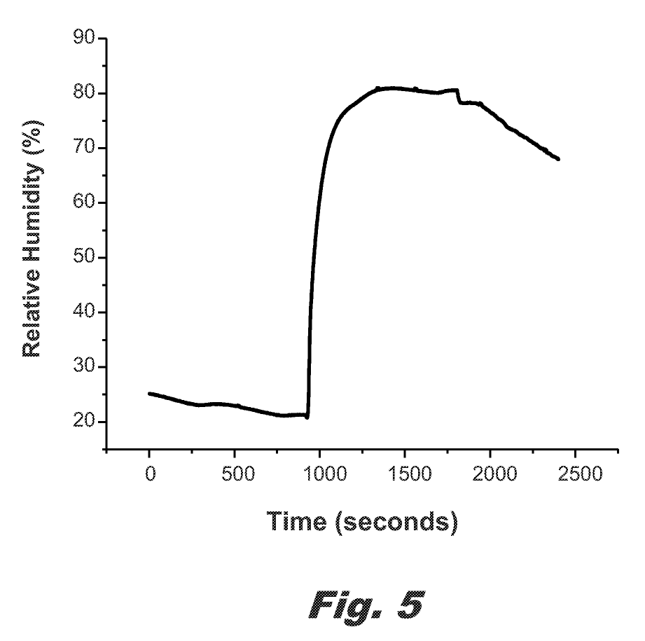

Once the equilibrium temperature and equilibrium relative humidity has been established in the napkin 40 as described above, the computer 24 and the LabView 7.1 software are used to begin collecting relative humidity data from the napkin 40. Data is collected for a fifteen minute period. After the initial fifteen minute period, the first plate 28 is removed and replaced with a new second plate 28, having the swatch of nonwoven material 36 attached thereto, that has been previously conditioned by leaving the plate 28 and material 36 in a room that is 22° C., +/−2° C. and 55%, +/−3.0% relative humidity for a period of twelve (12) hours. Prior to applying the second plate 28 to the napkin 40, 0.5 mL of water is applied to nonwoven material 36 using any conventional syringe. After the second plate 28 is applied relative humidity data for the napkin 40 is collected for an additional fifteen minute period. Thereafter, the second plate 28 is removed and relative humidity data for the napkin 40 is collected for an additional 10 minute period. Thus, relative humidity data is collected from the napkin 40 for a total of forty-five minutes. The relative humidity data collected from the napkin 40 is then used to generate a relative humidity (%) versus time (s) graph of the type shown in FIG. 5. The graph is generated using the data analysis and graphing software Origin 6.0 commercially available from OriginLab Corporation, Northampton, Mass.

As will be described in greater detail below the graph of relative humidity shown in FIG. 5 is used to calculate the humidity dissipation value A_{RH} of the napkin.

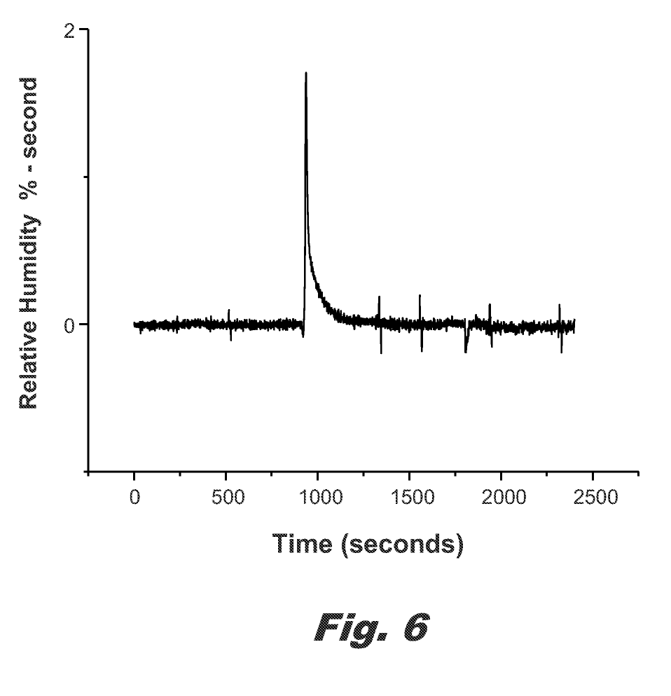

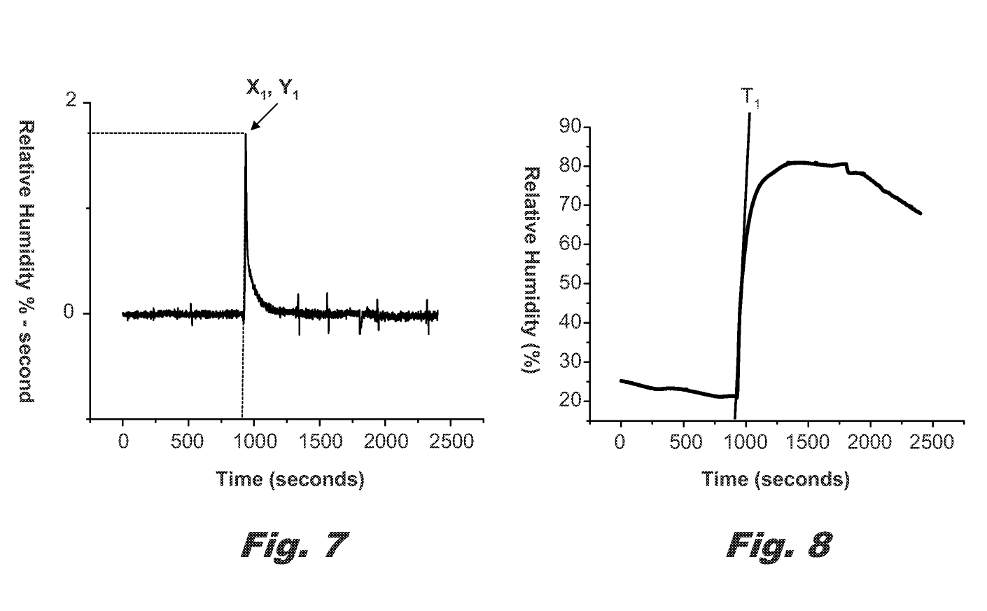

The A_{RH} calculation is performed as described below. First the differential of the graph shown in FIG. 5 is plotted to obtain a graph of the type shown in FIG. 6. Thereafter, as shown in FIG. 7, the maximum relative humidity %/second value, Y₁, is determined from the maximum value on the differential graph. Once the maximum value relative humidity %/second value, Y₁ is determined, the time at which this value occurs X₁ can be determined. Using the point defined by X₁ and Y₁, and the slope of the differential graph at this point, a first tangent line T₁ is obtained in time X₁ can be defined as shown in FIG. 8. The first tangent line T₁ is then transcribed on the graph shown in FIG. 5 as shown in FIG. 8. The tangent line T₁ is generated using the Origin 6.0 software.

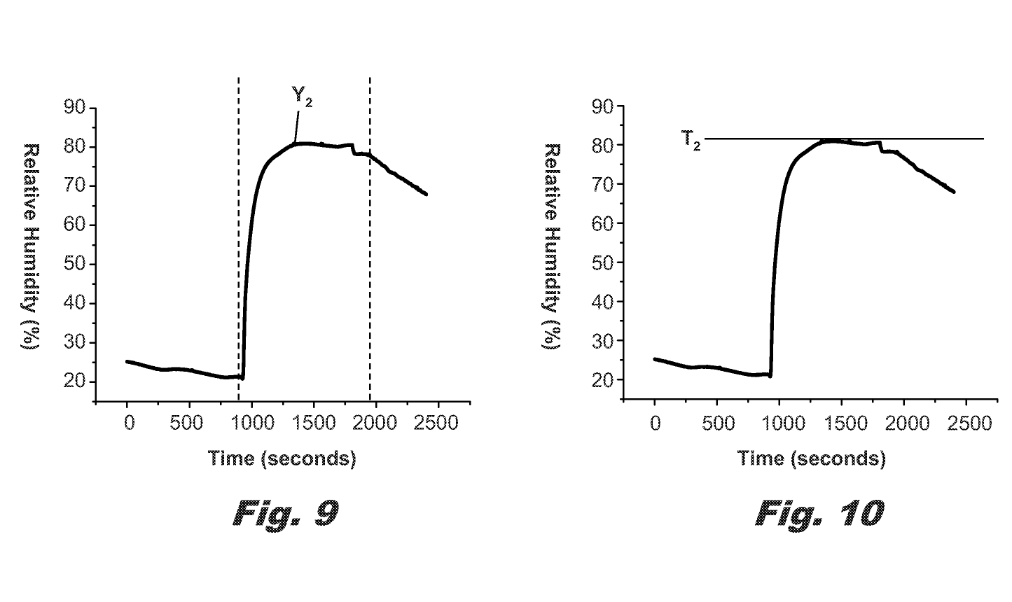

A second tangent line T₂ is determined by determining the maximum relative humidity % value, Y₂, on the graph shown in FIG. 5 between 900 s and 1800 s, as shown in FIG. 9. Using this maximum relative humidity % value, Y₂, and a slope of zero, a second tangent line T₂ can be defined. The second tangent line T₂ is transcribed on the graph shown in FIG. 5 as shown in FIG. 10. The tangent line T₂ is generated using the Origin 6.0 software.

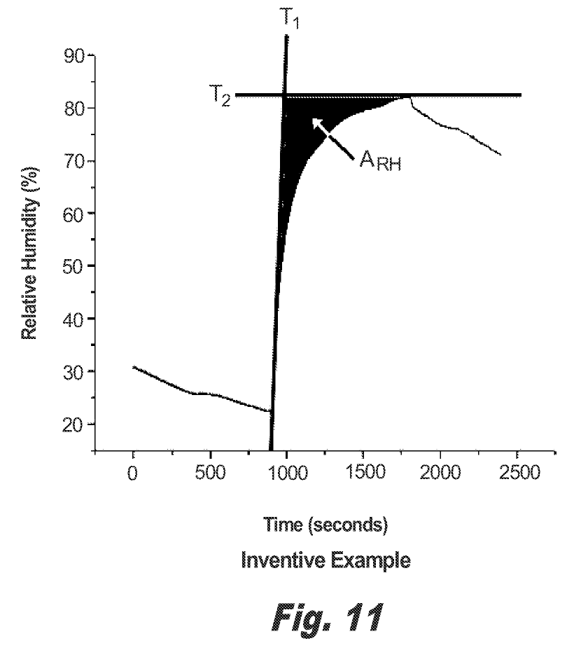

Once the first tangent line T₁ and second tangent line T₂ are transcribed on the graph shown in FIG. 5, as shown in FIG. 11, the area A_{RH} located between the graph line and first and second tangent lines is calculated using the Origin 6.0 software. The calculated area A_{RH} is inversely proportional to the relative humidity retention of the napkin 40. Stated another way the higher the A_{RH} the greater the humidity dissipation of the napkin 40. Thus, the higher the A_{RH} value the lower the relative humidity retention of the product and the cooler and more comfortable the product will feel during use.

The above described calculation is repeated for three identical product samples and an average A_{RH} is calculated.

The above described test method allows the evaluation of the humidity dissipation properties of an absorbent article and thereby allows one to predict the comfort attributes of the absorbent article.

We claim:

1. A method of calculating the humidity dissipation of an absorbent article comprising the steps of:
collecting relative humidity data from an absorbent article for a selected period of time;
generating a graph plotting relatively humidity versus time for the absorbent article;
differentiating the relative humidity versus time graph to obtain a differential graph;
obtaining a first tangent line from the differential graph;
obtaining a second tangent line from the relative humidity versus time graph;
transcribing the first and second tangent lines onto the relative humidity versus time graph; and
calculating a humidity dissipation A_{RH} value by determining the area located between the first and second tangent lines and the relative humidity versus time graph.

2. The method of claim 1, wherein prior to collecting the relative humidity date from the absorbent article an equilibrium temperature and an equilibrium relative humidity is established between the absorbent article and the laboratory in which the test method is being conducted.

3. The method of claim 2, wherein the step of collecting relative humidity data from the absorbent article includes the steps of:
collecting data from the absorbent article while the absorbent article is exposed to a moisture source;
removing the moisture source; and
collecting data from the absorbent article after the moisture source has been removed.

4. The method of claim 3, further comprising periodically applying a force to the moisture source to promote the transfer of moisture from the moisture source to the absorbent article.

5. The method of claim 4, further comprising arranging a relative humidity microsensor at an intersection of the longitudinally extending and laterally extending centerline of the absorbent article to thereby measure the relative humidity of the absorbent article.

6. The method of claim 5, wherein the microsensor is inserted into the absorbent core of the absorbent article.

7. The method of claim 1, wherein obtaining a first tangent line from the differential graph includes the steps of:
determining a maximum relative humidity %-s value, Y₁, from the differential graph;
determining a time X₁ at which the value Y₁ occurs;
using the slope of the differential graph at (X₁, Y₁) and the point defined by (X₁, Y₁) to thereby obtain the first tangent line in time X₁.

8. The method of claim 7, wherein obtaining a second tangent line from the differential graph includes the steps of:
determining a maximum relative humidity value, Y₂, from the relative humidity versus time graph;
using a slope of zero and the value Y₂ to thereby define the second tangent line.
